(19) United States
(12) Patent Application Publication
(10) Pub. No.: US 2018/0347664 A1
(43) Pub. Date: Dec. 6, 2018

(54) TORQUE DAMPENER FOR A VEHICLE PROPULSION SYSTEM

(71) Applicant: GM GLOBAL TECHNOLOGY OPERATIONS LLC, Detroit, MI (US)

(72) Inventor: Kirby S. Clark, Howell, MI (US)

(21) Appl. No.: 15/614,653

(22) Filed: Jun. 6, 2017

(51) Int. Cl. F16F 15/18; F16H 19/06

(52) U.S. Cl. CPC F16F 15/18; F16F 2222/06; F16H 19/06

(57) ABSTRACT

A magnetorheological dampener for a transmission of a vehicle propulsion system of a vehicle includes a rotor connected to a rotatable shaft of the transmission, a housing defining a cavity in which a portion of the rotor is positioned, a magnetorheological fluid within the cavity of the housing and in contact with a surface of the rotor and a surface of the housing opposing the surface of the rotor, an electromagnetic coil adapted to generate a magnetic field within the magnetorheological fluid, and a controller that controls activation of the electromagnetic coil.

### FIELD

The present disclosure relates to torque dampener for a vehicle propulsion system.

### INTRODUCTION

This introduction generally presents the context of the disclosure. Work of the presently named inventors, to the extent it is described in this introduction, as well as aspects of the description that may not otherwise qualify as prior art at the time of filing, are neither expressly nor impliedly admitted as prior art against this disclosure.

Vehicle propulsion systems may incorporate transfer gears that includes a drive pinion mated with an output or driven gear. These transfer gears have backlash designed into the system. Backlash is the clearance between the mating gear teeth that permits the gears to mesh without binding, to provide space for lubrication, and to enable assembly. Exemplary vehicle propulsion systems which include transfer gears include manual transmissions and dual clutch transmissions.

An exemplary dual clutch transmission 100 is illustrated in FIG. 1. The transmission 100 includes an input shaft 102, an output shaft 104, and a gearing arrangement 106. The input shaft 102 may be separate from the transmission 100 and form part of or be connected with a flywheel or other output from a prime mover (not shown). The output shaft 104 is rotatably driven by a final drive assembly 108. The transmission 100 further includes a dual clutch assembly 110. The gearing arrangement 106 includes a first input shaft 112, a second input shaft 114, a first countershaft 116, and a second countershaft 118. The second input shaft 114 is a sleeve shaft that is concentric with and overlies the first input shaft 112. The first and second countershafts, 116 and 118, are connected through first transfer gear 120 and second transfer gear 122, respectively, to the final drive assembly 108 via output transfer gear 124.

The dual clutch assembly 110 is connectable between the input shaft 102 and the first and second input shafts 112 and 114. The dual clutch assembly 110 includes a first clutch 126 for selectively engaging the input shaft 102 to the first input shaft 112 and a second clutch 128 for selectively engaging the input shaft 102 to the second input shaft 114.

The gearing arrangement 106 further includes a plurality of co-planar, intermeshing gear sets 130, 132, 134, 136, 138, 140, and 142, which each include intermeshing gear pairs. Intermeshing gear sets 130, 132, 134, and 136 are connected by respective intermeshing gear pairs to the second input shaft 114 and intermeshing gear sets 138, 140, and 142 are connected by respective intermeshing gear pairs to the first input shaft 112. Therefore, as is clearly illustrated by the exemplary dual clutch transmission of FIG. 1, both the first input shaft 112 and the second input shaft 114 are always connected to the output transfer gear 124 even though they are not always connected to the input shaft 102, via the dual clutch assembly 110. This structure lends itself to a problem. While one of the transfer shafts 112 or 114 may be transmitting a load, the other transfer shaft may have a gear set which has been pre-selected in anticipation for the next gear ratio change and which is not transmitting a load. The unloaded transfer shaft is still always connected to the output transfer gear 124. As a result, the unloaded state and the presence of backlash in the gears in the unloaded gear set may cause undesirable vibration, oscillations, and/or noise. The only thing which may resist the oscillations in that gear set may be the inertia in the unloaded transfer shaft and the very minimal friction from the bearings supporting that transfer shaft. However, the resistance to oscillations from these features is very limited.

### SUMMARY

In an exemplary aspect, a magnetorheological dampener for a transmission of a vehicle propulsion system of a vehicle includes a rotor connected to a rotatable shaft of the transmission, a housing defining a cavity in which a portion of the rotor is positioned, a magnetorheological fluid within the cavity of the housing and in contact with a surface of the rotor and a surface of the housing opposing the surface of the rotor, an electromagnetic coil adapted to generate a magnetic field within the magnetorheological fluid, and a controller that controls activation of the electromagnetic coil.

In another exemplary aspect, the controller controls activation of the electromagnetic coil to generate the magnetic field having an amplitude to which the magnetorheological fluid is responsive to have a predetermined shear stress amplitude.

In another exemplary aspect, the transmission includes a transfer gear.

In another exemplary aspect, the transfer gear includes a first pinion forming a portion of a first gear set in a dual clutch transmission and a second pinion forming a portion of a second gear set in the dual clutch transmission.

In another exemplary aspect, the controller activates the electromagnetic coil in response to the rotatable shaft being coupled to a transfer gear set and not transmitting a load.

In another exemplary aspect, the rotor includes a radially extending portion connected to the rotatable shaft of the transmission and a cylindrical portion positioned within the cavity defined by the housing.

In another exemplary aspect, a first seal is positioned between the cylindrical portion of the rotor and a first portion of the housing and a second seal is positioned between the cylindrical portion of the rotor and a second portion of the housing.

In another exemplary aspect, a gasket is positioned between a radially extending flange portion of the first housing portion and a radially extending flange portion of the second housing portion and the radially extending flange portion of both of the first housing portion and the second housing portion are connected to a fixed surface within the vehicle.

In another exemplary aspect, the magnetorheological fluid is positioned within a space defined by an outer surface of the cylindrical portion of the rotor and an inner surface of the housing opposing the outer surface of the cylindrical portion of the rotor, the first seal, the second seal, and the gasket.

In another exemplary aspect, the magnetorheological fluid is responsive to the magnetic field to change a shear stress between the outer surface of the cylindrical portion of the rotor and the inner surface of the housing opposing the outer surface of the cylindrical portion of the rotor.

In this manner, controllable damping is provided to a rotatable shaft in a transmission of a vehicle propulsion system which may eliminate and/or reduce vibrations and/or oscillations. Further, the damping can be selectively and variably applied which provides the opportunity to minimize drag losses when the dampening might not be needed. This is in stark contrast to conventional torque dampening systems which have a constant level of dampening. The inventive dampening system also enables adjustable variability to the amount of dampening such that it is adaptive to varying conditions and states of the associated transmission.

Further areas of applicability of the present disclosure will become apparent from the detailed description provided below. It should be understood that the detailed description and specific examples are intended for purposes of illustration only and are not intended to limit the scope of the disclosure.

The above features and advantages, and other features and advantages, of the present invention are readily apparent from the detailed description, including the claims, and exemplary embodiments when taken in connection with the accompanying drawings.

### BRIEF DESCRIPTION OF THE DRAWINGS

The present disclosure will become more fully understood from the detailed description and the accompanying drawings, wherein:

FIG. 1 is an exemplary dual clutch transmission for a vehicle propulsion system;

FIG. 2 is an exemplary torque dampener for a vehicle propulsion system;

FIG. 3 is a graph illustrating the relationship between shear rate and shear stress in a fluid having Bingham characteristics; and

FIG. 4 is a flowchart of an exemplary method in accordance with the present invention.

### DETAILED DESCRIPTION

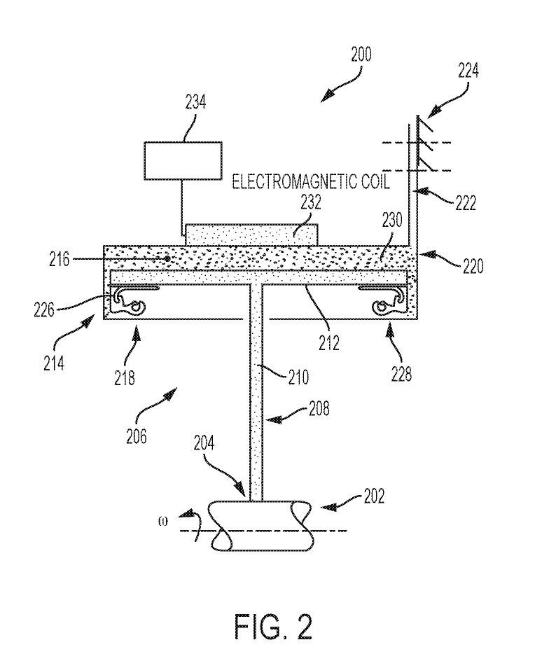

FIG. 2 illustrates an exemplary torque dampener 200 for a vehicle propulsion system. The torque dampener 200 operates to selectively dampen the torque of a torque transmitting shaft 202. The torque transmitting shaft 202 may form any portion of a vehicle propulsion system without limitation. The torque transmitting shaft 202 may, for example, form a portion of the dual clutch transmission 100, such as, one or more of the first input shaft 112, the second input shaft 114, the first countershaft 116, and the second countershaft 118, and the like. It is to be understood that the torque transmitting shaft 202 may form any torque transmitting portion of a vehicle propulsion system without limitation.

The shaft assembly 202 is connected, via a connection 204, to a magnetorheological torque dampener 206. The magnetorheological torque dampener 206 includes a rotor 208 that includes a radially extending portion 210 and a cylindrical portion 212. The cylindrical portion 212 of the rotor 208 is positioned within a cavity 216 defined by a housing 214. The housing 214 includes a first housing portion 218 and a second housing portion 220. The magnetorheological torque dampener 206 further includes a gasket 222 positioned between radially extending flange portions of each of the first housing portion 218 and second housing portion 220 to form a seal between them. The housing 214 is held stationary by fastening the radially extending flange portions to a fixed surface 224.

The housing 214 further encompasses a first seal 226 and a second seal 228, which further defines the cavity 216. The cavity 216 is filled with a magnetorheological fluid 230 that is reactive to the application of a magnetic field (not shown) from an electromagnetic coil 232. The electromagnetic coil 232 is in communication with and controlled by controller 234. Adjusting the viscosity of the magnetorheological fluid 230 through the application and modulation of a magnetic field results in a controllably variable drag torque to be induced on the cylindrical portion 212 of the rotor 208. Since the rotor 208 is connected to the shaft assembly 202, the rotor 208 rotates together with the shaft assembly 202 and any drag torque from the magnetorheological fluid 230 upon the cylindrical portion 212 of the rotor 208 is transferred to the shaft assembly 202. In this manner, the torque dampener 200 may controllably and variably dampen the oscillations of the shaft assembly 202.

The magnetorheological fluid 230 may be selected to provide a very low viscosity in the absence of a magnetic field to minimize any drag torque that may be applied to the shaft assembly 202. Further, the magnetorheological fluid 230 and the strength of the magnetic field that is applied to the magnetorheological fluid 230 from the electromagnetic coil 232 may be calibrated and adjusted to optimize the damping such that it minimizes vibrations and/or oscillations that would otherwise occur within the shaft assembly 202.

While the magnetorheological torque dampener of FIG. 2 has rotor with generally t-shaped cross-section, it is understood that a magnetorheological torque dampener that is connected to a transmission shaft of a vehicle propulsion system may have any structure, shape and/or configuration without limitation and form an exemplary embodiment of the present invention.

The magnetorheological torque dampener 200 of FIG. 2 includes seals formed by gasket 222, first seal 226, and second seal 228, which have been positioned within the housing 214 in a manner which minimizes the volume of the magnetorheological fluid that is captured within the cavity defined by those seals and the housing. Further, the two-piece construction of the housing 214 along with the positioning of the seals provides for easy and simple assembly.

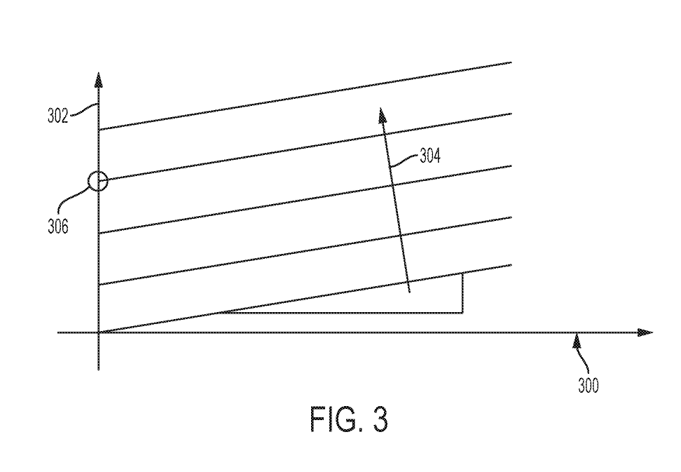

The amount torque dampening and/or braking that may be applied by the torque dampener to the shaft assembly 202 may be determined based upon a number of factors. In an exemplary embodiment, the magnetorheological fluid may be a suspension of magnetically soft particles, such as, for example, carbonyl iron microspheres with a chemically anchored surfactant, in a synthetic hydrocarbon or silicone base fluid. In the absence of a magnetic field the magnetorheological fluid is a fluid with a random dispersion of magnetizable particles that exhibits Newtonian rheological behavior. A Newtonian fluid is a fluid in which the viscous stresses arising from its flow is linearly proportional to the shear rate. However, in the presence of a magnetic field, a magnetorheological fluid aligns the metal particles into fibrous structures. In this state, the magnetorheological fluid changes from exhibiting Newtonian fluid characteristics to that of a Bingham fluid characteristics in which the shear stress is a function of the yield stress as well as the shear rate. The yield stress is determined by the magnitude of an applied magnetic field as illustrated by FIG. 3.

In the graph of FIG. 3, the shear rate is represented by the horizontal axis 300 and the shear stress is represented by the vertical axis 302. The shear rate is the relative velocity between, for example, the outer surface of the cylindrical portion 212 of the rotor 208 and the internal surface of the housing 214 opposing the cylindrical surface 212. Each sloped line on the graph represents an amount of shear stress in a magnetorheological fluid as the flux density 304 of an applied magnetic field increases. As is clearly illustrated, for any given flux density, even at a zero shear rate, there is an amount of yield stress which contributes to the overall shear stress, an example of which is indicated at 306. An equation representing the shear stress characteristics is:

$$T = T 0 + u * r * ( \frac{s}{h} )$$

Where T is the shear stress, TO is the zero slip yield shear stress, μ is the dynamic viscosity, r is the radius of the surface, s is the slip across the gap between surfaces, and h is the constant flux density of the magnetorheological fluid.

The amount of torque that may by applied by the torque dampener may further be determined based upon the geometry of the torque dampener. For example, the above equation may be modified to compensate for the dimensions and geometry of the torque dampener of FIG. 2. It is understood by those of ordinary skill in the art of magnetorheological fluids that the amount of shear stress is also affected by the area of the relevant surfaces undergoing shear strain.

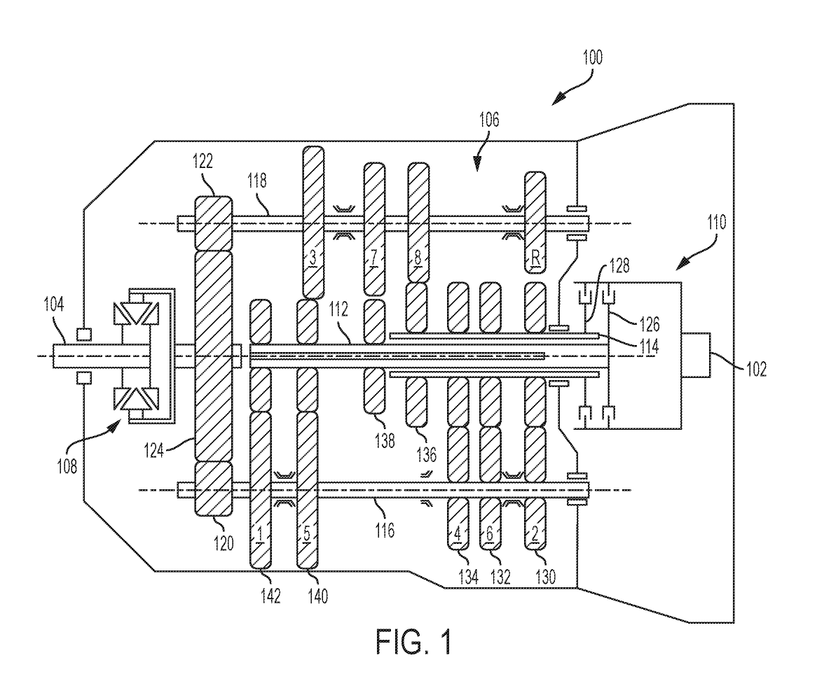

In an exemplary embodiment, the magnetorheological torque dampener may be coupled to one or more of the shafts in a transmission of a vehicle propulsion system. For example, the magnetorheological torque dampener may be coupled to one or more of the first input shaft 112, the second input shaft 114, the first countershaft 116, and the second countershaft 118 of the dual clutch transmission of FIG. 1. The magnetorheological torque dampener may then selectively be controlled to apply torque dampening to an unloaded, but engaged transfer gear set to minimize or eliminate vibrations or oscillations that would otherwise occur.

The controller 234 of the magnetorheological torque dampener may selectively energize the electromagnetic coil 232 to provide a magnetic field having an amplitude which causes the magnetorheological torque dampener to dampen the oscillations of the connected transfer gear set shaft. In an exemplary embodiment, the controller 234 may selectively operate the magnetorheological torque dampener in response to pre-synchronization of a non-load transmitting transfer gear in a transmission of a vehicle propulsion system.

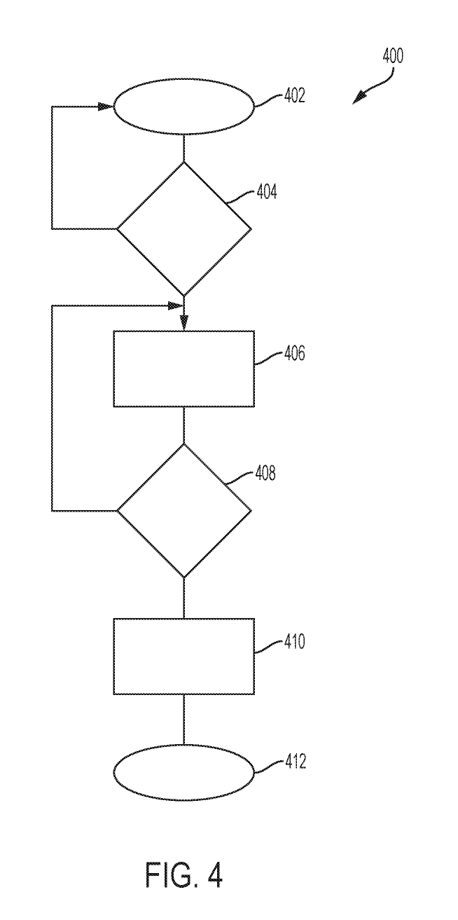

An exemplary method for controlling the magnetorheological torque dampener is illustrated by the flowchart 400 of FIG. 4. The method starts at step 402 and continues to step 404, in step 404 the controller 234 determines whether a gear set within the transmission of the vehicle propulsion system has been pre-synchronized and is not transmitting a load. If, in step 404, the controller 234 determines that a gear set within the transmission of the vehicle propulsion system has been pre-synchronized and is not transmitting a load, then the method continues to step 406. If, however, in step 404, the controller 234 determines that a gear set within the transmission of the vehicle propulsion system has not been pre-synchronized and is not transmitting a load, then the method returns to step 402. In step 406, the controller 234 controls the electromagnetic coil 232 in the magnetorheological torque dampener so that the magnetorheological torque dampener applies a dampening torque which minimizes and/or eliminates the potential for oscillations within the pre-synchronized, and unloaded gear set that is connected to the magnetorheological torque dampener. The method then continues to step 408. In step 408, the controller 234 determines whether the gear set connected to the magnetorheological torque dampener is loaded. If, in step 408, the controller 234 determines that the magnetorheological torque dampener is loaded, then the method continues to step 410. In step 410, the controller 234 deactivates the magnetorheological torque dampener and continues to step 412. The method stops in step 412. If, however, in step 408, the controller determines that the pre-synchronized gear set continues to be unloaded, then the method returns to step 406 where the magnetorheological torque dampener continues to apply a dampening torque.

In other exemplary methods, the controller 234 may selectively activate and modulate the amplitude of the applied magnetic field based upon predetermined characteristics of the vehicle propulsion system transmission that are acquired during calibration procedures. Alternatively, other exemplary methods may activate the magnetic field in response to other transmission configurations and state changes.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A magnetorheological dampener for a transmission of a vehicle propulsion system of a vehicle, the dampener comprising:
a rotor connected to a rotatable shaft of the transmission;
a housing defining a cavity in which a portion of the rotor is positioned;
a magnetorheological fluid within the cavity of the housing and in contact with a surface of the rotor and a surface of the housing opposing the surface of the rotor;
an electromagnetic coil adapted to generate a magnetic field within the magnetorheological fluid; and
a controller that controls activation of the electromagnetic coil.

2. The dampener of claim 1, wherein the controller controls activation of the electromagnetic coil to generate the magnetic field having an amplitude to which the magnetorheological fluid is responsive to have a predetermined shear stress amplitude.

3. The dampener of claim 1, wherein the transmission comprises a transfer gear.

4. The dampener of claim 1, wherein the transfer gear comprises a first pinion forming a portion of a first gear set in a dual clutch transmission and a second pinion forming a portion of a second gear set in the dual clutch transmission.

5. The dampener of claim 1, wherein the controller activates the electromagnetic coil in response to the rotatable shaft being coupled to a transfer gear set and not transmitting a load.

6. The dampener of claim 1, wherein the rotor comprises a radially extending portion connected to the rotatable shaft of the transmission and a cylindrical portion positioned within the cavity defined by the housing.

7. The dampener of claim 6, further comprising a first seal positioned between the cylindrical portion of the rotor and a first portion of the housing and a second seal positioned between the cylindrical portion of the rotor and a second portion of the housing.

8. The dampener of claim 7, further comprising a gasket positioned between a radially extending flange portion of the first housing portion and a radially extending flange portion of the second housing portion and wherein the radially extending flange portion of both of the first housing portion and the second housing portion are connected to a fixed surface within the vehicle.

9. The dampener of claim 8, wherein the magnetorheological fluid is positioned within a space defined by an outer surface of the cylindrical portion of the rotor and an inner surface of the housing opposing the outer surface of the cylindrical portion of the rotor, the first seal, the second seal, and the gasket.

10. The dampener of claim 9, wherein the magnetorheological fluid is responsive to the magnetic field to change a shear stress between the outer surface of the cylindrical portion of the rotor and the inner surface of the housing opposing the outer surface of the cylindrical portion of the rotor.

11. A vehicle propulsion system of a vehicle, the system comprising:
a rotor connected to a rotatable shaft of the transmission;
a housing defining a cavity in which a portion of the rotor is positioned;
a magnetorheological fluid within the cavity of the housing and in contact with a surface of the rotor and a surface of the housing opposing the surface of the rotor;
an electromagnetic coil adapted to generate a magnetic field within the magnetorheological fluid; and
a controller that controls activation of the electromagnetic coil.

12. The system of claim 11, wherein the controller controls activation of the electromagnetic coil to generate the magnetic field having an amplitude to which the magnetorheological fluid is responsive to have a predetermined shear stress amplitude.

13. The system of claim 11, wherein the transmission comprises a transfer gear.

14. The system of claim 11, wherein transfer gear comprises a first pinion forming a portion of a first gear set in a dual clutch transmission and a second pinion forming a portion of a second gear set in the dual clutch transmission.

15. The system of claim 11, wherein the controller activates the electromagnetic coil in response to the rotatable shaft being coupled to a transfer gear set and not transmitting a load.

16. The system of claim 11, wherein the rotor comprises a radially extending portion connected to the rotatable shaft of the transmission and a cylindrical portion positioned within the cavity defined by the housing.

17. The system of claim 16, further comprising a first seal positioned between the cylindrical portion of the rotor and a first portion of the housing and a second seal positioned between the cylindrical portion of the rotor and a second portion of the housing.

18. The system of claim 17, further comprising a gasket positioned between a radially extending flange portion of the first housing portion and a radially extending flange portion of the second housing portion and wherein the radially extending flange portion of both of the first housing portion and the second housing portion are connected to a fixed surface within the vehicle.

19. The system of claim 18, wherein the magnetorheological fluid is positioned within a space defined by an outer surface of the cylindrical portion of the rotor and an inner surface of the housing opposing the outer surface of the cylindrical portion of the rotor, the first seal, the second seal, and the gasket.

20. The system of claim 19, wherein the magnetorheological fluid is responsive to the magnetic field to change a shear stress between the outer surface of the cylindrical portion of the rotor and the inner surface of the housing opposing the outer surface of the cylindrical portion of the rotor.
